(19) United States
(12) Patent Application Publication
(10) Pub. No.: US 2024/0185307 A1
(43) Pub. Date: Jun. 6, 2024

(54) METHODS, SYSTEMS, AND MEDIA FOR DETERMINING CURVED ADVERTISEMENT VIEWABILITY IN VIRTUAL ENVIRONMENTS

(71) Applicant: Integral Ad Science, Inc., New York, NY (US)

(72) Inventors: Prashant Jawale, Pune (IN); Tanishq Nimale, Pune (IN); Adarsh Singh, Pune (IN); Abhishek Vyas, Jalgaon (IN); Vinay Gaykar, Pune (IN)

(21) Appl. No.: 18/531,419

(22) Filed: Dec. 6, 2023

Related U.S. Application Data
(60) Provisional application No. 63/430,627, filed on Dec. 6, 2022.

(51) Int. Cl. G06Q 30/0241

(52) U.S. Cl. CPC G06Q 30/0277

(57) ABSTRACT

Methods, systems, and media for determining curved advertisement viewability in virtual environments are provided. In some embodiments, the method comprises: receiving, using a hardware processor, a content identifier for an advertising object in a virtual environment, wherein the advertising object contains an advertising image; identifying, using the hardware processor, a viewport and a view frustum for a user in the virtual environment; determining, using the hardware processor, a set of viewability metrics comprising (i) a location of a center of the advertising object relative to a boundary of the view frustum, wherein the location is within the boundary of the view frustum; (ii) a relative alignment between the advertising image and the viewport, wherein the relative alignment comprises an angle between a normal of the advertising object in a region where the advertising image is located and a direction vector between the origin of the viewport and a center of the advertising object; (iii) a relative scale of the advertising object, wherein the relative scale comprises a relative distance combined with a field of view of the view frustum, wherein the relative distance comprises a distance between the origin of the viewport and the center of the advertising object; and (iv) an amount of the advertising image that is visible to the user, comprising: producing a plurality of rays that originate at a center of the viewport and are oriented towards the advertising object, determining a quantity of rays from the plurality of rays that intersect at least one point on the advertising image; and determining a combination of the quantity of rays that intersect at least one point on the advertising image and a total quantity of rays in the plurality of rays; and, in response to determining the set of viewability metrics, associating, using the hardware processor, the target advertisement with a viewability rating.

### CROSS-REFERENCE TO RELATED APPLICATIONS

This application claims the benefit of U.S. Provisional Patent Application No. 63/430,627, filed Dec. 6, 2022, which is hereby incorporated by reference herein in its entirety.

### TECHNICAL FIELD

The disclosed subject matter relates to methods, systems, and media for determining curved advertisement viewability in virtual environments. More particularly, the disclosed subject matter relates to determining advertisement viewability information of advertisements appearing on curved surfaces of three-dimensional virtual objects.

### BACKGROUND

Many people use virtual environments for video gaming, social networking, work activities, and increasingly more activities. Such virtual environments can be highly dynamic, and can have robust graphics processing capabilities that produce realistic lighting, shading, and particle systems, such as snow, leaves, smoke, etc. While these effects can provide a rich user experience, they can also affect digital advertising content that has been placed in the virtual environment. It can be difficult for advertisers to track viewability for their advertisements due to the many variables present in the virtual environment.

Additionally, many virtual environments use three-dimensional graphics to illustrate scenery, user avatars, non-playable characters, and other in-world objects. One aspect of three-dimensional graphics that adds to the realistic experience of a virtual environment is the use of curved surfaces in the virtual environment. For example, curved surfaces can appear in building designs and in objects, such as balloons and cylindrical components (e.g., tree trunks, bridge columns, etc.) that users encounter throughout the virtual environment. Such surfaces also present opportunities for digital advertisements to be presented on the curved surfaces. However, measuring the viewability of a curved surface can be a difficult task for advertisers.

Accordingly, it is desirable to provide new mechanisms for determining curved advertisement viewability in virtual environments.

### SUMMARY

Methods, systems, and media for determining curved advertisement viewability in virtual environments are provided.

In accordance with some embodiments of the disclosed subject matter, a method for determining advertisement viewability in a virtual environment is provided, the method comprising: receiving, using a hardware processor, a content identifier for an advertising object in a virtual environment, wherein the advertising object contains an advertising image; identifying, using the hardware processor, a viewport and a view frustum for a user in the virtual environment; determining, using the hardware processor, a set of viewability metrics comprising (i) a location of a center of the advertising object relative to a boundary of the view frustum, wherein the location is within the boundary of the view frustum; (ii) a relative alignment between the advertising image and the viewport, wherein the relative alignment comprises an angle between a normal of the advertising object in a region where the advertising image is located and a direction vector between the origin of the viewport and a center of the advertising object; (iii) a relative scale of the advertising object, wherein the relative scale comprises a relative distance combined with a field of view of the view frustum, wherein the relative distance comprises a distance between the origin of the viewport and the center of the advertising object; and (iv) an amount of the advertising image that is visible to the user, comprising: producing a plurality of rays that originate at a center of the viewport and are oriented towards the advertising object, determining a quantity of rays from the plurality of rays that intersect at least one point on the advertising image; and determining a combination of the quantity of rays that intersect at least one point on the advertising image and a total quantity of rays in the plurality of rays; and, in response to determining the set of viewability metrics, associating, using the hardware processor, the target advertisement with a viewability rating.

In some embodiments, the relative alignment further comprises a relative rotation between the viewport and the center of the advertising object.

In some embodiments, the boundary of the view frustum is a plurality of planes.

In some embodiments, the viewability rating is determined based on a combination of the set of viewability metrics.

In some embodiments, the combination further comprises weighting each metric in the set of viewability metrics with a non-zero weight.

In some embodiments, at least a portion of the advertising object contains a curved surface.

In accordance with some embodiments of the disclosed subject matter, a system for determining advertisement viewability in a virtual environment is provided, the system comprising a hardware processor that is configured to: receive a content identifier for an advertising object in a virtual environment, wherein the advertising object contains an advertising image; identify a viewport and a view frustum for a user in the virtual environment; determine a set of viewability metrics comprising (i) a location of a center of the advertising object relative to a boundary of the view frustum, wherein the location is within the boundary of the view frustum; (ii) a relative alignment between the advertising image and the viewport, wherein the relative alignment comprises an angle between a normal of the advertising object in a region where the advertising image is located and a direction vector between the origin of the viewport and a center of the advertising object; (iii) a relative scale of the advertising object, wherein the relative scale comprises a relative distance combined with a field of view of the view frustum, wherein the relative distance comprises a distance between the origin of the viewport and the center of the advertising object; and (iv) an amount of the advertising image that is visible to the user, comprising: producing a plurality of rays that originate at a center of the viewport and are oriented towards the advertising object, determining a quantity of rays from the plurality of rays that intersect at least one point on the advertising image; and determining a combination of the quantity of rays that intersect at least one point on the advertising image and a total quantity of rays in the plurality of rays; and, in response to determining the set of viewability metrics, associate the target advertisement with a viewability rating.

In accordance with some embodiments of the disclosed subject matter, a non-transitory computer-readable medium containing computer executable instructions that, when executed by a processor, cause the processor to perform a method for determining advertisement viewability in a virtual environment is provided, the method comprising: receiving a content identifier for an advertising object in a virtual environment, wherein the advertising object contains an advertising image; identifying a viewport and a view frustum for a user in the virtual environment; determining a set of viewability metrics comprising (i) a location of a center of the advertising object relative to a boundary of the view frustum, wherein the location is within the boundary of the view frustum; (ii) a relative alignment between the advertising image and the viewport, wherein the relative alignment comprises an angle between a normal of the advertising object in a region where the advertising image is located and a direction vector between the origin of the viewport and a center of the advertising object; (iii) a relative scale of the advertising object, wherein the relative scale comprises a relative distance combined with a field of view of the view frustum, wherein the relative distance comprises a distance between the origin of the viewport and the center of the advertising object; and (iv) an amount of the advertising image that is visible to the user, comprising: producing a plurality of rays that originate at a center of the viewport and are oriented towards the advertising object, determining a quantity of rays from the plurality of rays that intersect at least one point on the advertising image; and determining a combination of the quantity of rays that intersect at least one point on the advertising image and a total quantity of rays in the plurality of rays; and, in response to determining the set of viewability metrics, associating the target advertisement with a viewability rating.

In accordance with some embodiments of the disclosed subject matter, a system for determining advertisement viewability in a virtual environment is provided, the system comprising: means for receiving a content identifier for an advertising object in a virtual environment, wherein the advertising object contains an advertising image; means for identifying a viewport and a view frustum for a user in the virtual environment; means for determining a set of viewability metrics comprising (i) a location of a center of the advertising object relative to a boundary of the view frustum, wherein the location is within the boundary of the view frustum; (ii) a relative alignment between the advertising image and the viewport, wherein the relative alignment comprises an angle between a normal of the advertising object in a region where the advertising image is located and a direction vector between the origin of the viewport and a center of the advertising object; (iii) a relative scale of the advertising object, wherein the relative scale comprises a relative distance combined with a field of view of the view frustum, wherein the relative distance comprises a distance between the origin of the viewport and the center of the advertising object; and (iv) an amount of the advertising image that is visible to the user, comprising: producing a plurality of rays that originate at a center of the viewport and are oriented towards the advertising object, determining a quantity of rays from the plurality of rays that intersect at least one point on the advertising image; and determining a combination of the quantity of rays that intersect at least one point on the advertising image and a total quantity of rays in the plurality of rays; and means for associating the target advertisement with a viewability rating in response to determining the set of viewability metrics.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is an example illustration of a three-dimensional environment having advertisements on curved surfaces in accordance with some embodiments of the disclosed subject matter.

FIG. 2 is an example flow diagram of an illustrative process for determining curved advertisement viewability in virtual environments in accordance with some embodiments of the disclosed subject matter.

FIG. 3 is an example flow diagram of an illustrative process for determining viewability metrics for a curved advertisement in a virtual environment in accordance with some embodiments of the disclosed subject matter.

FIG. 4A is an example illustration of an object within a view frustum of a virtual environment in accordance with some embodiments of the disclosed subject matter.

FIG. 4B is an example illustration of an object partially within a view frustum of a virtual environment in accordance with some embodiments of the disclosed subject matter.

FIG. 5A is an example illustration of two objects having relative rotations in accordance with some embodiments of the disclosed subject matter.

FIG. 5B is an example illustration of two objects in a virtual environment with relative rotations in accordance with some embodiments of the disclosed subject matter.

FIG. 6 is an example illustration of relative scale for an advertisement on a curved surface in a virtual environment in accordance with some embodiments of the disclosed subject matter.

FIG. 7 is an example illustration of ray casting on a curved advertisement in accordance with some embodiments of the disclosed subject matter.

FIG. 8 is an example block diagram of a system that can be used to implement mechanisms described herein in accordance with some implementations of the disclosed subject matter.

FIG. 9 is an example block diagram of hardware that can be used in a server and/or a user device in accordance with some implementations of the disclosed subject matter.

### DETAILED DESCRIPTION

In accordance with various embodiments of the disclosed subject matter, mechanisms (which can include methods, systems, and media) for determining curved advertisement viewability in virtual environments are provided.

Digital advertisements are commonly found in webpages and computer applications, such as banner advertisements and mid-roll advertisements placed at the top and middle (respectively) of a block of text, and pre-roll video advertisements played before a feature video. In a virtual environment that is immersive, such as a video game or other interactive three-dimensional environment, advertisements can be added to many different surfaces and integrated into the gameplay or environment through a variety of creative approaches. For example, an advertisement can be placed in a virtual environment on an object that mimics the appearance of advertisements in the off-line world, such as billboards. Alternatively, advertisers and designers can choose to add branding or advertisement content to virtual objects in a way that could be very challenging in the off-line world, such as placing content on curved surfaces such as balloons and/or other abstract and artisanal shapes in the virtual environment.

In both approaches, tracking when and how well the advertisements perform in the virtual environment, which is a necessary component of advertising, also needs new and creative approaches. To address this, advertisers and designers can collect metrics regarding how users interact with the virtual environment.

In some embodiments, the mechanisms described herein can receive a content identifier for a particular virtual object that has been configured to display advertising content (e.g., an advertising object) in the virtual environment. In some embodiments, the advertising object can display one or more advertising image(s) on the surface of the advertising object. In some embodiments, mechanisms can locate a viewport and a view frustum for an active user in the virtual environment, particularly when the user is active in a region near the advertising object. In some embodiments, the viewport and/or view frustum can be associated with a virtual camera controlled by the active user. In some embodiments, the mechanisms described herein can determine a set of viewability metrics relating the user to the advertising object.

In some embodiments, determining the set of viewability metrics can include determining if the advertising object is in the view frustum of the user, quantifying the relative alignment between the advertising image on the advertising object and the viewport of the user, quantifying a relative size of the advertising object as it appears in the viewport of the user (e.g., a relative scale), and/or how much of the advertising object and/or advertising image are in direct view of the user.

In particular, determining how much of the advertising object is in view of the user can comprise any suitable technique, such as ray casting from the user location (e.g., the virtual camera) to the advertising object and/or image, and determining a percentage of rays from the ray casting that do not arrive at the advertising object and/or advertising image. That is, using a ray casting technique to determine if there are objects between the user and the advertising object that can block the user's line-of-sight to the advertising object.

In some embodiments, the mechanisms described herein can combine the viewability metrics to determine an overall viewability rating for the advertising image. In some embodiments, the mechanisms can track the viewability metrics for one or more users while the one or more users are in a predefined region near the advertising object. In some embodiments, the mechanisms can associate the viewability rating with an advertising database accessible to the advertiser.

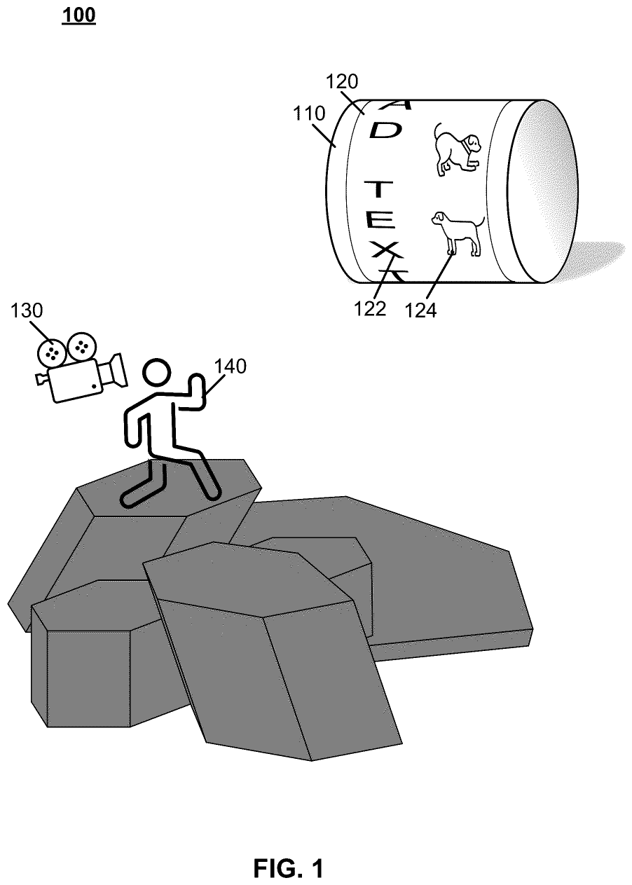

These and other features for determining curved advertisement viewability in virtual environments are described further in connection with FIGS. 1-9.

Turning to FIG. 1, an example illustration 100 of a three-dimensional virtual environment having advertisements on curved surfaces in accordance with some embodiments of the disclosed subject matter is shown. As shown, illustration 100 can include an advertising object 110 having an advertising region 120 along with a camera 130 and a user avatar 140.

In some embodiments, the virtual environment can be any suitable three-dimensional immersive experience accessed by a user wearing a headset and/or operating any other suitable peripheral devices (e.g., game controller, game pad, walking platform, flight simulator, any other suitable vehicle simulator, etc.). In some embodiments, the virtual environment can be a program operated on a user device wherein the program graphics are three-dimensional and are displayed on a two-dimensional display.

In some embodiments, advertising object 100 can be a virtual object in a virtual environment. For example, in some embodiments, advertising object 100 can be a digital billboard, sign, and/or any other suitable advertising surface on a three-dimensional virtual object. In another example, in some embodiments, advertising object 100 can be a digital balloon, and/or any other shape that includes a curved surface.

In some embodiments, advertising object 110 can be any suitable three-dimensional geometric shape. For example, as shown in FIG. 1, advertising object 110 can be a cylindrical object. In some embodiments, advertising object 110 can be a solid object or a hollow surface (e.g., a shell). In another example, advertising object 110 can include any suitable quantity and/or radius of curvature, such as a sphere, an ovoid, a balloon, a cone, a torus, and/or any other suitable shape (e.g., abstract shapes).

In some embodiments, advertising object 110 can have any suitable texture, color, pattern, shading, lighting, transparency, and/or any other suitable visual effect. In some embodiments, advertising object 110 can have any suitable size and/or dimensions. In some embodiments, advertising object 110 can have any suitable physics properties consistent with the general physics of the virtual environment. For example, in some embodiments, advertising object 110 can float in the sky, and can additionally move when any other object collides with advertising object 110 (e.g., wind, users, etc.).

In some embodiments, advertising object 110 can be identified in the virtual environment through any suitable mechanism or combination of mechanisms, including a content identifier (e.g., alphanumeric string), a shape name, a series of coordinates locating the geometric centroid (center of mass) of the object, a series of coordinates locating vertices of adjoining edges of the object, and/or any other suitable identifier(s).

In some embodiments, advertising object 110 can contain an advertising region 120 for advertising content 122 (e.g., text, such as “AD TEXT”) and 124 (e.g., pet imagery). In particular, as shown in FIG. 1, advertising content 122 and 124 can be presented on the curved surface of advertising object 110. In some embodiments, advertising region 120 can be any suitable quantity and/or portion of the surface of advertising object 110, and can include any suitable text, images, graphics, and/or visual aids to display advertising content.

In some embodiments, advertising content presented in advertising region 120 can be static. In some embodiments, advertising content presented in advertising region 120 can be periodically refreshed or changed. In particular, advertising object 110 and advertising region 120 can be used to serve targeted advertisements, using any suitable mechanism, to a particular user while the particular user is within a certain vicinity of advertising object 120. Note that, in some embodiments, multiple users can be within a predetermined vicinity of advertising object 110, and the virtual environment can present separate targeted advertising content in advertising region 120 to each user. In some embodiments, a content identifier for advertising object 110 can additionally include any suitable information regarding the active advertising content in advertising region 120 for a particular user.

In some embodiments, camera 130 can be associated with any suitable coordinate system and/or projection. In some embodiments, the virtual environment can allow users to select their preferred projection (e.g., first-person view, third-person view, orthographic projection, etc.), and camera 130 can be associated with any suitable virtual object used to generate the selected projection. For example, in some embodiments, in a third-person perspective projection, camera 130 can be associated with the origin of the viewing frustum and/or viewport. In some embodiments, for any projection, a view frustum within the virtual environment can be generated, wherein the view frustum includes at least a region of the virtual environment that can be presented to a user. In some embodiments, a viewport of the virtual environment can be generated, wherein the viewport can include a projection of the region within the view frustum onto any surface. In some embodiments, the viewport can be two-dimensional. In another example, in some embodiments, camera 130 can be associated with the user's avatar in a first-person perspective projection.

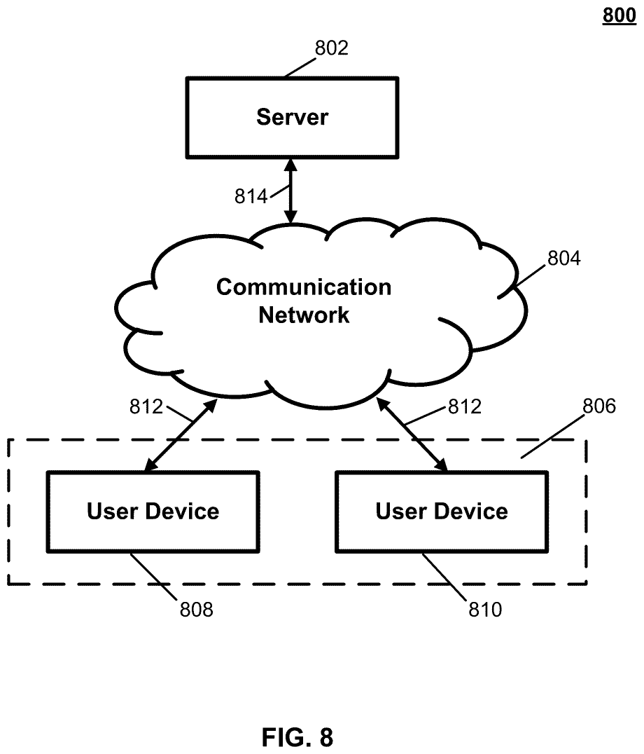

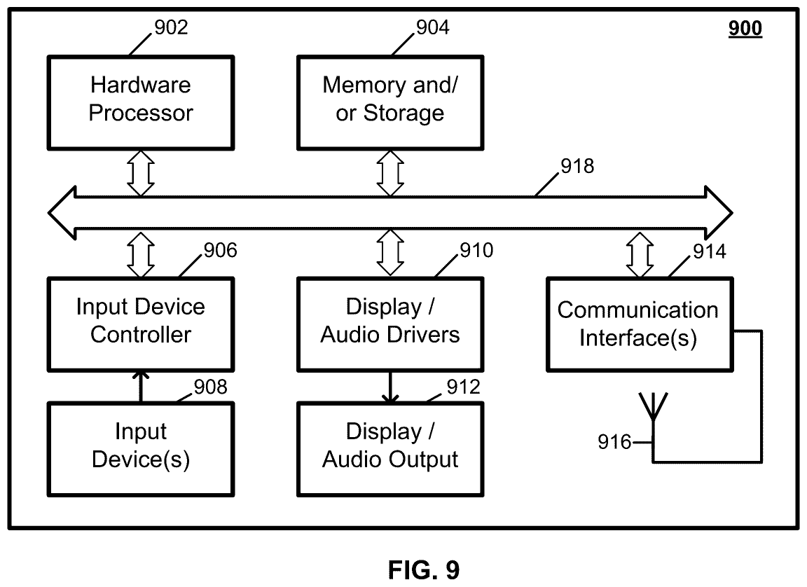

In some embodiments, user 140 can be any suitable user of the virtual environment. In some embodiments, user 140 can be associated with any suitable identifier, such as a user account, username, screen name, avatar, and/or any other identifier. In some embodiments, user 140 can access the virtual environment through any suitable user device, such as the user devices 806 as discussed below in connection with FIG. 8. In some embodiments, any suitable mechanism can designate user 140 as an “active” user. For example, in some embodiments, user 140 can display any suitable amount of movement in the virtual environment within a given timespan (e.g., one minute, two minutes, five minutes, etc.). In another example, in some embodiments, user 140 can interact with the virtual environment through any suitable input, such as a keyboard, mouse, microphone, joystick, and/or any other suitable input device as discussed below in connection with input devices 908 in FIG. 9. In some embodiments, a user can be switched from an “active” designation to an “inactive” designation by any suitable mechanism. For example, in some embodiments, user 140 can display a lack of movement in the virtual environment within a given timespan (e.g., one minute, two minutes, five minutes, etc.). In another example, in some embodiments, user 140 can cease to send any input to the virtual environment. Note that, user 140 can be designated “inactive” while the user account and/or user device are still accessing computing resources of the virtual environment. In some embodiments, a user can be designated as “offline” once user 140 no longer accesses computing resources of the virtual environment.

In some embodiments, the virtual environment can use any suitable three-dimensional coordinate system to identify objects, other users and/or avatars within the virtual environment, and/or non-playable characters. For example, in some embodiments, the virtual environment can use a global coordinate system to locate positions of fixed objects. In another example, in some embodiments, the virtual environment can use a local coordinate system when considering the position and orientation of camera 130 and/or user 140. That is, in some embodiments, objects can be referenced according to a distance from the local origin of the camera 130 and/or user 140. In some embodiments, any suitable object within the virtual environment can be assigned an object coordinate system, and in some embodiments, the objects can have a hierarchical coordinate system such that a first object is rendered with respect to the position of a second object. In some embodiments, the virtual environment can use another coordinate system to reference objects rendered within the view frustum relative to the boundaries of the view frustum. In some embodiments, the virtual environment can employ a viewport coordinate system that collapses any of the above-referenced three-dimensional coordinate systems into a two-dimensional (planar) coordinate system, with objects referenced relative to the center and/or any other position of the viewport.

In some embodiments, the virtual environment can use multiple coordinate systems simultaneously, and can convert coordinates from one system (e.g., local coordinate system) to another system (e.g., global coordinate system) and vice-versa, as required by user movement within the virtual environment. In some embodiments, any coordinate system used by the virtual environment can be a left-handed coordinate system or a right-handed coordinate system.

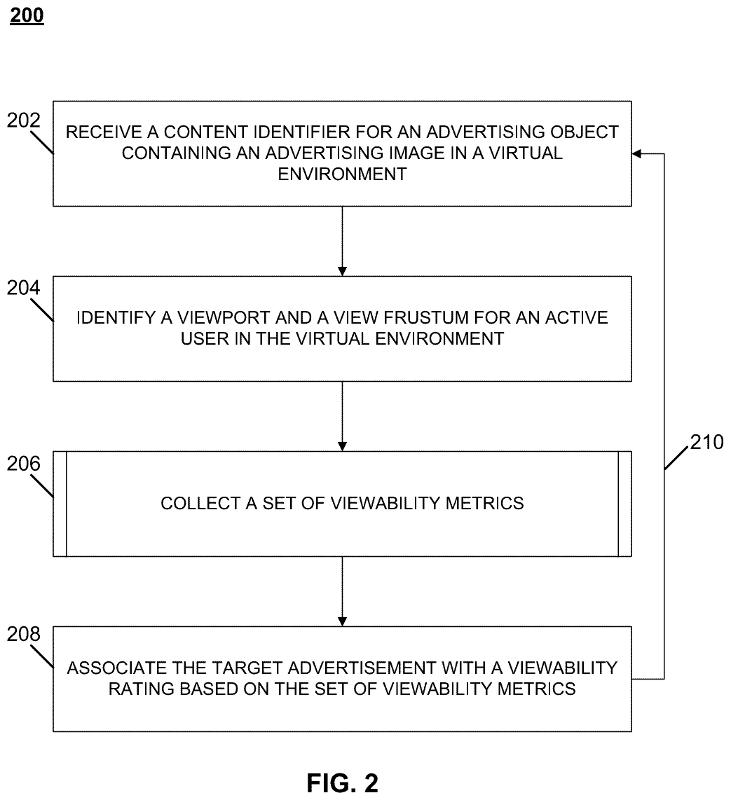

Turning to FIG. 2, an example flow diagram of an illustrative process 200 for determining curved advertisement viewability in virtual environments in accordance with some embodiments of the disclosed subject matter is shown. In some embodiments, process 200 can be executed on any suitable device, such as server 802 and/or user devices 806 discussed below in connection with FIG. 8.

As shown, process 200 can begin at block 202 in some embodiments when a server and/or user device receives a content identifier for an advertising object containing an advertising image. For example, as discussed above in connection with FIG. 1, process 200 can receive a content identifier for advertising object 110 containing advertisement content in advertisement region 120. Continuing this example, in some embodiments, the content identifier can include any suitable information regarding the text, images, graphics, and/or visual aids included in the advertising content. Note that, in some embodiments, the content identifier can include a list of all advertising content configured to be displayed and can indicate which advertising content is displayed at the current moment.

In some embodiments, at block 204, process 200 can identify an active user in the virtual environment and can additionally identify a camera, viewport, view frustum, and/or any other suitable objects associated with the three-dimensional projection and/or user's perspective in the virtual environment. For example, in some embodiments, process 200 can determine that a virtual environment has any suitable quantity of users logged in to the virtual environment, and that a particular user is moving through the virtual environment within a particular vicinity to the advertising object indicated by the content identifier received at block 202.

In some embodiments, at block 206, process 200 can use any suitable mechanism to collect a set of viewability metrics. In some embodiments, the set of viewability metrics can describe (qualitatively and/or quantitatively) how the user and the advertising content on the advertising object can interact. For example, in some embodiments, the set of viewability metrics can indicate that the user has walked in front of the advertising object. In another example, in some embodiments, the set of viewability metrics can include measurements regarding the alignment between the user and the advertising object.

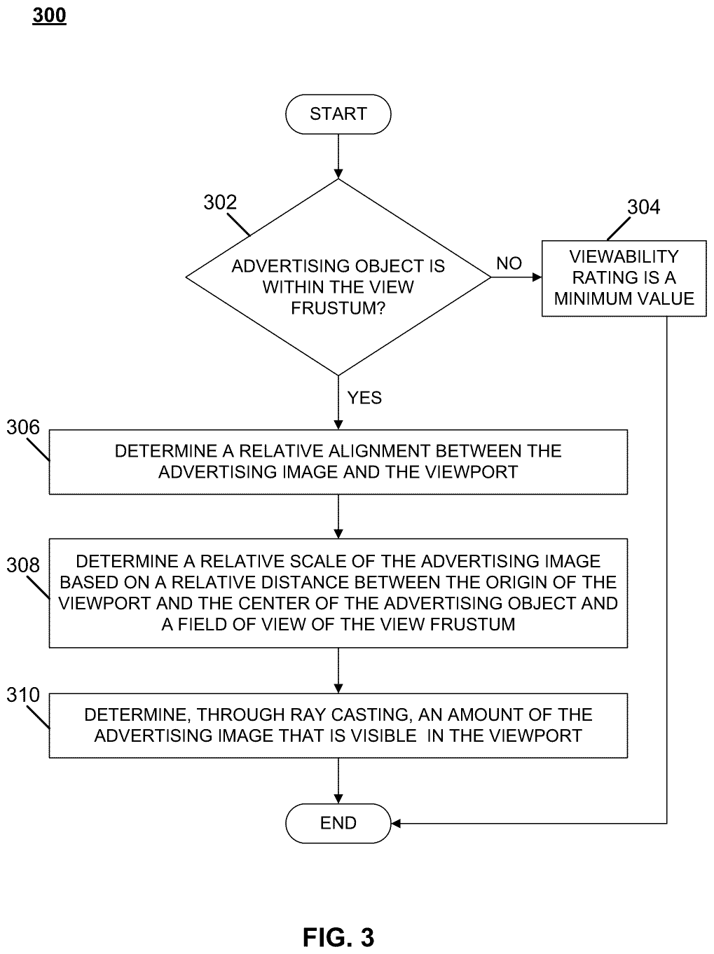

In some embodiments, the set of viewability metrics can include any suitable quantity of metrics. In some embodiments, the set of viewability metrics can be a series of numbers, e.g., from 0 to 100. For example, in some embodiments, the set of viewability metrics can include a determination that the advertising object was rendered in the view frustum and can include a value of ‘100’ for the corresponding metric. In some embodiments, any suitable process, such as process 300 as described below in FIG. 3, can be used to collect the set of viewability metrics.

In some embodiments, at block 208, process 200 can associate the advertising object and/or advertising image with a viewability rating based on the set of viewability metrics. For example, in some embodiments, when one or more viewability metrics are qualified (e.g., have a descriptor such as, “partially viewed”), process 200 can use any suitable mechanism to convert the qualified viewability metric(s) to a numeric value. In another example, in some embodiments, when one or more viewability metrics are quantized (e.g., have a numeric value), process 200 can combine the set of viewability metrics in any suitable combination.

In some embodiments, the viewability rating can be any suitable combination and/or output of a calculation using the set of viewability metrics. For example, the viewability rating can be a sum, a weighted sum, a maximum value, a minimum value, and/or any other representative value from the set of viewability metrics. In some embodiments, the viewability metrics can include a range of values for each metric. For example, as discussed below in connection with FIG. 3, a relative alignment metric can include a range of values for alignment between the camera angle of the virtual camera (e.g., controlled by the user) and the advertising object. In this example, the relative alignment metric can include an amount of time spent at each angle, and a total amount of time that the relative alignment was within a predetermined range of angles. Other viewability metrics can similarly include a range of values and/or table of values that were logged throughout a period of time.

In some embodiments, the viewability rating can be stored at block 208 of process 200 using any suitable mechanism. In some embodiments, the viewability rating can be stored in a database containing advertising information. In some embodiments, the viewability rating can be associated with a record of the advertising object and/or the advertising image. In some embodiments, the viewability rating can be stored with any suitable additional information, such as an indication of the user and/or type of user (user ID and/or screen name or alternatively an advertising ID for the user, avatar/character description, local time for the user, type of device used within the virtual environment, etc.), and/or any other suitable information from the virtual environment. For example, additional information from the virtual environment as relating to the viewability rating of the advertising object can include: time of day in the virtual environment, quantity of active users within a predetermined vicinity of the advertising object since the start of process 200, amount of time used to compute the viewability metrics at block 206, if the advertising image was interrupted and/or changed during the execution of process 200 (e.g., when the advertising object is a billboard with a rotating set of advertising graphics as discussed above at block 202).

In some embodiments, process 200 can loop at 210. In some embodiments, process 200 can execute any suitable number of times and with any suitable frequency. In some embodiments, process 200 can be executed in a next iteration using the same content identifier for the same advertising object. For example, in some embodiments, process 200 can loop at 210 when a new active user is within a certain distance to the advertising object.

In some embodiments, separate instances of process 200 can be executed for each active user in a region around the advertising object. In some embodiments, block 204 of process 200 can contain a list of all active users in a predetermined vicinity of the advertising object, and the remaining blocks of process 200 can be executed on a per-user and/or aggregate basis for all of the active users in the predetermined vicinity of the advertising object.

In some embodiments, process 200 can end at any suitable time. For example, in some embodiments, process 200 can end when there are no active users within a vicinity of the advertising object. In another example, in some embodiments, process 200 can end when the active user is no longer participating in the virtual environment (e.g., has logged off, is idle and/or inactive, etc.). In yet another example, in some embodiments, process 200 can end after a predetermined number of iterations.

Turning to FIG. 3, an example flow diagram of an illustrative process 300 for determining viewability metrics for curved advertisements in accordance with some embodiments of the disclosed subject matter is shown. In some embodiments, process 300 can be executed as a sub-process of any other suitable process, such as process 200 for determining curved advertisement viewability in virtual environments as described above in connection with FIG. 1. In some embodiments, process 300 can receive and/or can access the content identifier received at block 202 of process 300 and the camera, viewport, and/or view frustum identified at block 204 of process 300, in addition to any other suitable information and/or metadata regarding the virtual environment, advertising object and/or advertising image, and active user.

In some embodiments, process 300 can begin at block 302 by determining whether the advertising object is within the view frustum.

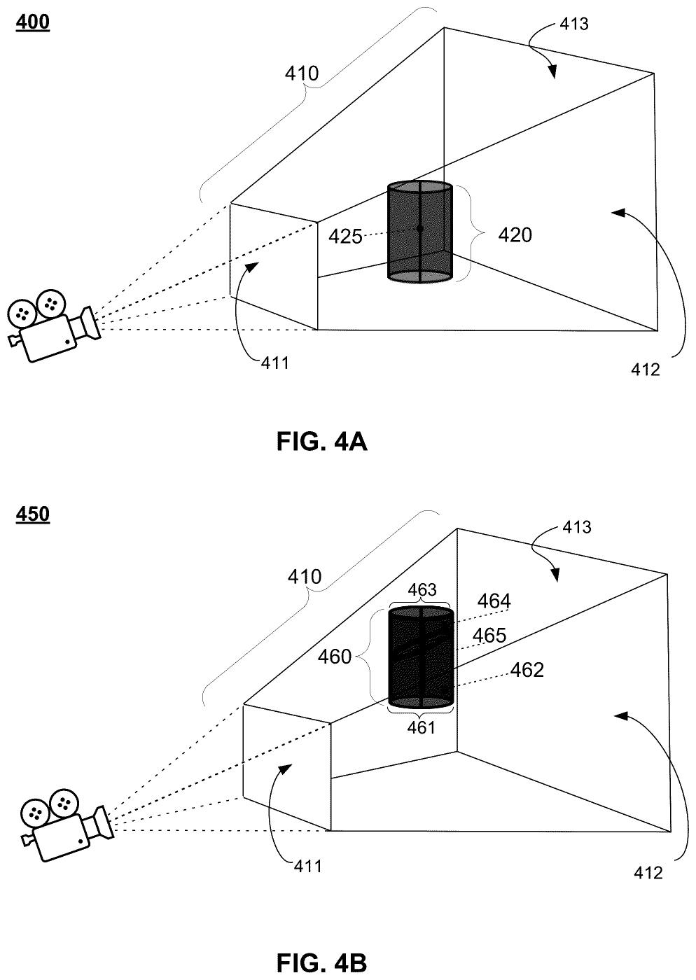

In some embodiments, if a substantial portion of the advertising object is outside of any plane (or combination of planes) that defines the view frustum, then process 300 can determine that the advertising object is not within the view frustum and can proceed to block 304. For example, as discussed below in connection with FIG. 4B, illustration 450 shows an example of an advertising object that is only partially within the view frustum. In another example, if more than a particular portion of the advertising object is outside of any plan that defines the view frustum (e.g., more than a particular percentage set by the advertiser), process 300 can determine that the advertising object is not within the view frustum and can proceed to block 304.

At block 304, process 300 can provide a viewability rating that is set to a minimum value, such as zero, null, and/or any other numeric value indicating that the advertising object was not within the view frustum. In some embodiments, process 300 can provide a viewability rating that is scaled to the amount of the advertising object that was within the view frustum. For example, in some embodiments, process 300 can use the determination from block 302 to calculate that approximately half (50%) of the advertising object was within the view frustum, then process 300 can assign a viewability rating value of 0.5 for the advertising object.

In some embodiments, at block 302, process 300 can alternatively determine that the advertising object is within the view frustum. That is, in some embodiments, process 300 can determine that the center of the advertising object lies within the region of virtual space defined by the view frustum. For example, as discussed below in connection with FIG. 4A, illustration 400 shows an example of an advertising object within the view frustum. In some embodiments, when all of the advertising object is determined to be within the view frustum, process 300 can determine that the advertising object is within the view frustum and can proceed to block 306.

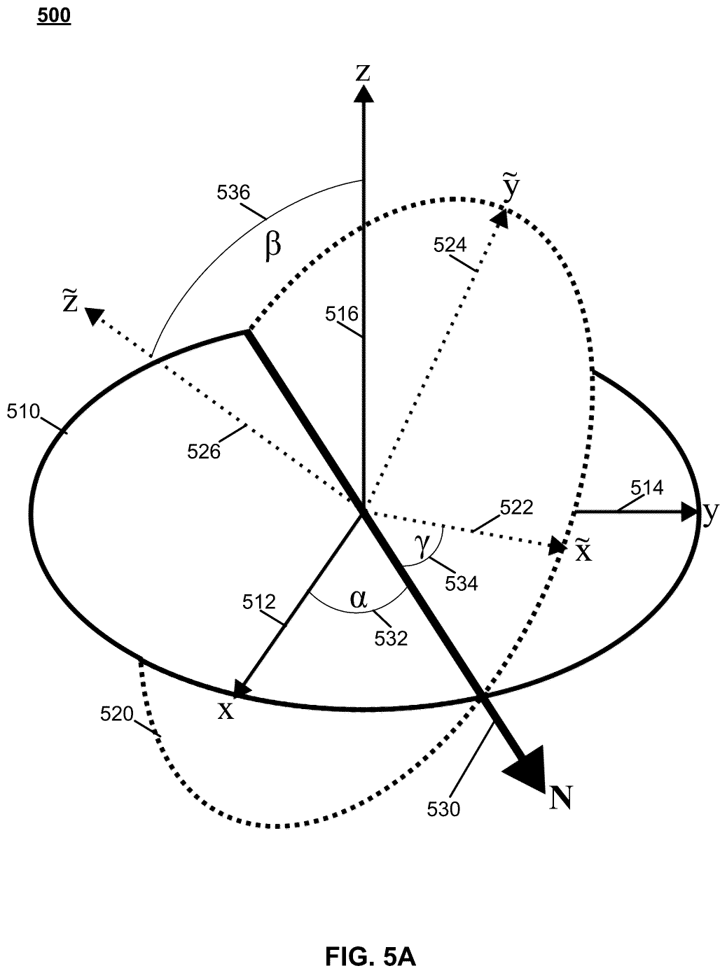

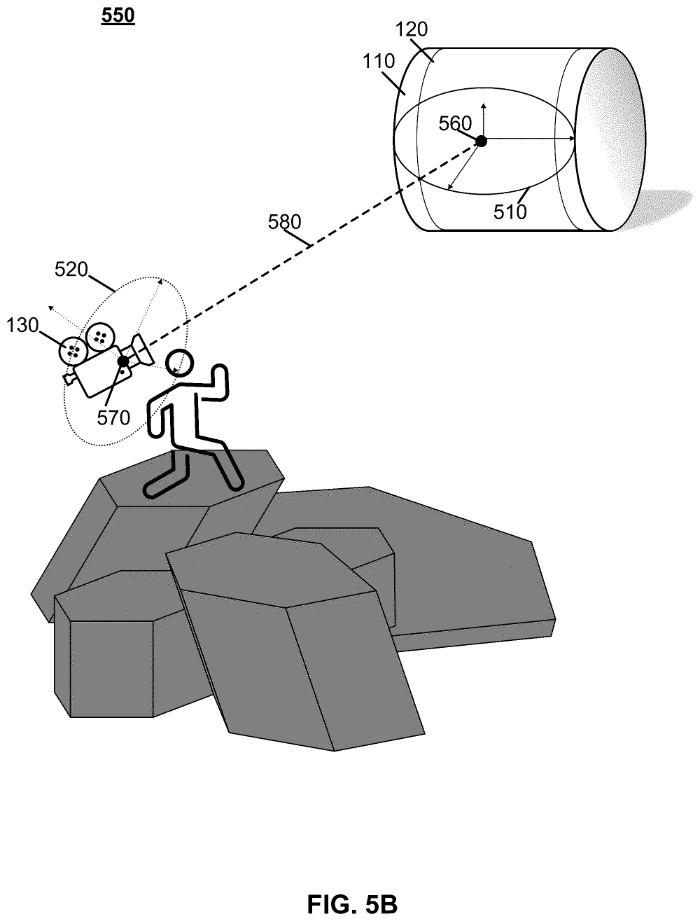

In some embodiments, at block 306, process 300 can determine a relative alignment between the advertising image and the user. In some embodiments, process 300 can use a position of the user (e.g., a camera position within the global coordinate system of the virtual environment) to determine the distance between the user and the center of the advertising image. In addition to the distance, process 300 can determine an angle between the user (e.g., an orientation of the camera, a viewport, and/or a view frustum) and the advertising object. In some embodiments, process 300 can calculate the angle between the normal vector of the advertising object and the distance vector between the user and the advertising image, as described below in connection with FIG. 5.

In some embodiments, at block 306, process 300 can include a rotation of the camera and/or a rotation of the advertising image relative to the advertising object in the determination of relative alignment. For example, in some embodiments, the advertising image can appear to be rotated relative to an axis of the advertising object, such as when the advertising image is a rectangular shape wrapped around a cylindrical advertising object. Continuing this example, in some embodiments, the advertising image can be positioned with a slant relative to the z-axis (height) of the cylindrical advertising object. In some embodiments, process 300 can include such orientation of the advertising object in the determination of the relative alignment between the user and the advertising object and/or advertising image.

In some embodiments, process 300 can use any suitable technique to quantify the relative alignment between the user and the advertising image and/or advertising object. For example, in some embodiments, process 300 can determine the Euler rotation angles (α, γ, β) between a coordinate system (x, y, z) for the advertising object and a coordinate system (\tilde{x}, \tilde{y}, \tilde{z}) for the camera, as shown in illustration 500 of FIG. 5A. In this example, in some embodiments, a range of Euler rotation angles can be assigned to any suitable quantization scale. As a particular example, in some embodiments, when the Euler rotation angles (α, γ, β) are (10°, 45°, 10°), process 300 can quantify the relative alignment as “80%” aligned and can include a value of “0.8” as a viewability metric for alignment. In some embodiments, quantifying the relative alignment can indicate a probability that the advertisement image appears on the display screen of the active user.

At block 308, process 300 can determine a relative scale of the advertising image based on the relative distance between the origin of the viewport and the center of the advertising object. That is, in some embodiments, by considering the field of view of the view frustum and the relative distance, process 300 can determine a relative scale of the advertising image. For example, in some embodiments, if the relative distance between the user and the advertising image is large, then the advertising image is likely to be far away and consequentially, small compared to objects which are closer (e.g., have a small value of relative scale). In another example, in some embodiments, when the relative distance between the user and the advertising image is small, then the advertising image is likely to be close, have a larger relative scale, and consequentially, the user is more likely to understand the overall content and message (e.g., imagery, text, etc.) being delivered by the advertising image.

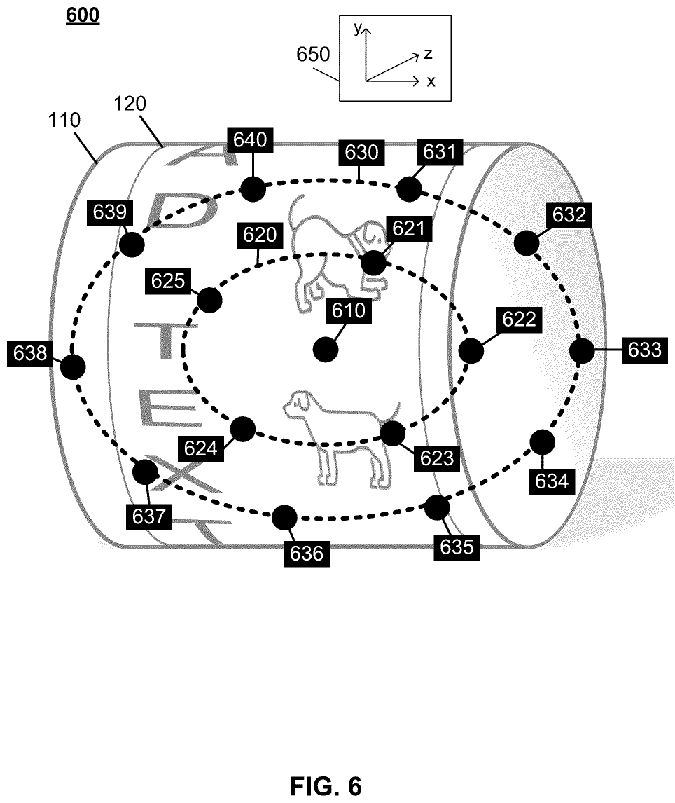

In some embodiments, at block 308, process 300 can calculate a series of points on and/or near the advertising image and/or advertising object, and can use the series of points to determine a size of the advertising image that appears in the viewport. For example, in some embodiments, process 300 can use a series of points arranged along ellipses as discussed below in connection with FIG. 6. In some embodiments, process 300 can quantify the relative scale using any suitable mechanism. For example, in some embodiments, process 300 can use the ellipses and/or points 610-640 discussed below in connection with FIG. 6 to determine a quantitative value for the relative scale for the advertising object at 208.

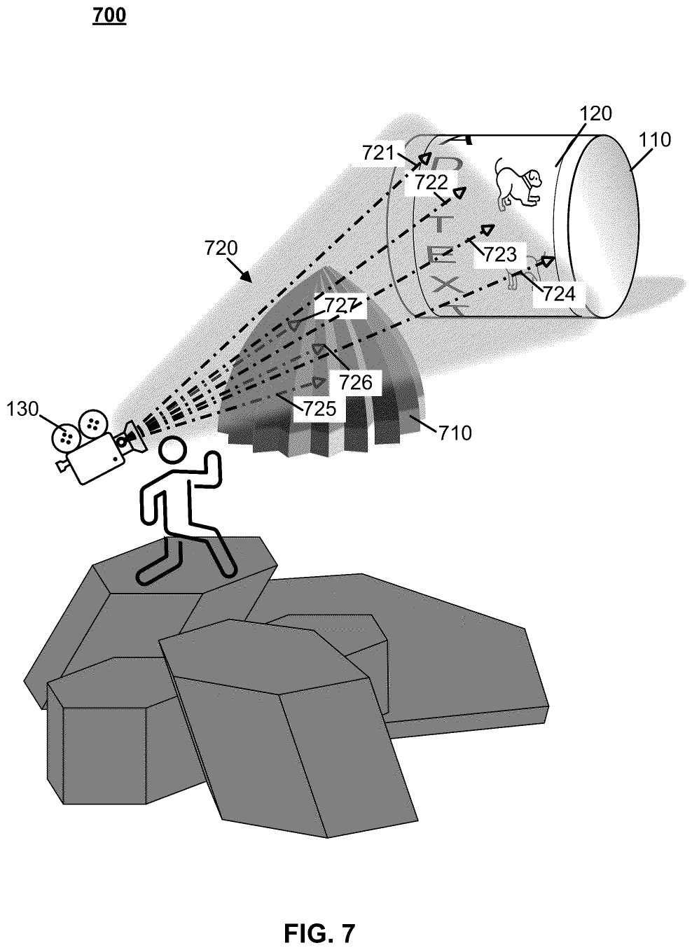

At block 310, process 300 can determine, through ray casting, an amount of the advertising image that is visible in the viewport. In particular, in some embodiments, process 300 can determine a percentage of the advertising object and/or advertising image that is obscured by another object between the user and the advertising object. As discussed below in connection with illustration 700 of FIG. 7, process 300 can quantify the percentage of the advertisement image that encounters a primary collision with a ray that originates at the camera of the active user as a viewability metric. For example, in some embodiments, process 300 can determine that approximately 10% of a particular advertising image is obstructed in the top right-hand corner, and can report that the advertising image is 90% un-obscured in the set of viewability metrics. In some embodiments process 300 can additionally include any suitable information, such as the coordinates and/or region(s) of the advertising image that are obstructed as determined at block 310.

In some embodiments, process 300 can end after any suitable analysis. In some embodiments, process 300 can compile the viewability metrics as discussed above at blocks 302-312. In some embodiments, process 300 can include any additional information such as an amount of processing time used to compile each and/or all of the viewability metrics at blocks 302-312. In some embodiments, process 300 can include multiple quantitative and/or qualitative values for any of the visibility metrics. For example, in some embodiments, process 300 can sample any metric at a predetermined frequency (e.g., once per second, or 1 Hz) from any one of blocks 306-312 for a given length of time (e.g., ten seconds) while a user is moving through the virtual environment. In this example, process 300 can have ten samples for any one or more of the metrics determined in blocks 306-312. Continuing this example, in some embodiments, process 300 can include the entirety of the sample set, with each sample paired with a timestamp, in the set of visibility metrics. That is, process 300 can include a series of ten values of an alignment metric and an associated timestamp for when the alignment metric was determined. As a particular example, in some embodiments, a user can be panning the environment (e.g., through control of the virtual camera) and thus changing their relative alignment to the advertising object. Continuing this particular example, in some embodiments, process 300 can track the user's panning activity and can report the range of angles of the relative alignment that were determined while the user was panning. Additionally, the user can be moving closer to the advertising object while panning, which can also affect the size of the advertising object and the amount of the advertising object that is visible in the viewport. Process 300 can therefore track each of the respective metrics while the user motion is occurring, and can include a user position (e.g., using world coordinates), time stamp, and/or any other information when tabulating the set of viewability metrics.

In some embodiments, process 300 can end by storing the set of visibility metrics (and associated info as discussed above) in a storage location and/or memory of the device that was executing process 300 and/or any other suitable device with data storage.

Turning to FIGS. 4A and 4B, example illustrations 400 and 450 of a view frustum 410 with objects in a virtual environment in accordance with some embodiments are shown. In some embodiments, as shown in example illustration 400, view frustum 410 can include a near plane 411, a far plane 412, a top plane 413, a bottom plane, a left plane and/or a right plane. In some embodiments, view frustum 410 can be a truncated pyramid. In some embodiments, any suitable mechanism, such as process 300, can determine some and/or all of the coordinates which comprise the boundaries of view frustum 410. In some embodiments, view frustum 410 can be any other suitable geometry, such as a cone. In some embodiments, objects within the virtual environment that are not within the view frustum for the active user can be culled, that is, not rendered by the graphics processing routines of the virtual environment.

As shown, the outer surface of view frustum 410, defined by the six planes as noted above, can converge to a virtual camera 430. In some embodiments, view frustum 410 can have any suitable length in the virtual environment, including an infinite length, and/or any other suitable predetermined length. In some embodiments, the length of view frustum 410 can be determined by the distance from the near plane 411 to the far plane 412. In some embodiments, near plane 411 can be positioned at any distance between virtual camera 430 and far plane 412. In some embodiments, far plane 412 can be positioned at any distance from near plane 411.

In some embodiments, determining if an advertising object is in the view frustum can comprise determining a first (e.g., two-dimensional, three-dimensional) position 425 at the center of advertising object 420 within the virtual environment. Based on this determination, mechanisms can comprise comparing the first position 425 of advertising object 420 to the boundaries of view frustum 410 to determine if the first position 425 is in view frustum 410 of the virtual environment. As shown in FIG. 4A, the first position 425 can be within the boundaries of view frustum 410. Accordingly, in some embodiments, mechanisms can comprise determining that advertising object 420 is in view frustum 410 of the virtual environment.

As shown in FIG. 4B, advertising object 460 is partially in view frustum 410. As shown, a first portion 461 of advertising object 460 can be positioned in view frustum 410, and a second portion 463 of advertising object 460 can be positioned outside view frustum 410. As shown, advertising object 460 can intersect top surface 413 of view frustum 410. As shown, a first position 462 of advertising object 460 can be within the boundaries of view frustum 410. As shown, a second position 464 of advertising object 460 is not within the boundaries of view frustum 410.

In some embodiments, if at least one position of an advertising object is in the view frustum, mechanisms can comprise determining that the advertising object is in the view frustum. Accordingly, since the first position 462 is in view frustum 410, mechanisms according to some embodiments can comprise determining that advertising object 460 is in the view frustum.

In some embodiments, if at least one position of an advertising object is not within the view frustum, mechanisms can comprise determining that the advertising object is not in the view frustum. Accordingly, since the second position 464 is not within the boundaries of view frustum 410, mechanisms according to some embodiments can comprise determining advertising object 460 is not within the frustum.

In some embodiments, mechanisms can comprise determining where the intersection of top plane 413 and advertising object 460 occurs within the volume spanned by advertising object 460. In some embodiments, mechanisms can comprise determining what percentage of the total volume of advertising object 460 is contained within the portion inside the view frustum (e.g., first portion 461) and within the portion outside the view frustum (e.g., second portion 463).

Turning to FIG. 5A, an example illustration 500 to determine rotation angles between two rigid bodies is shown in accordance with some embodiments of the disclosed subject matter. As shown, a first rigid body can be represented as an ellipse 510 which has a three-dimensional coordinate system of x 512, y 514, and z 516. In some embodiments, the first rigid body can correspond to the advertising object, with the origin of the coordinate system (x, y, z) set to the geometric center of the advertising object. In some embodiments, the first rigid body can correspond to the advertising object, with the origin of the coordinate system (x, y, z) set to the center of the advertising image on the advertising object.

Additionally, as shown and in some embodiments, a second rigid body can be represented as an ellipse 520 which has a three-dimensional coordinate system of \tilde{x} 522, \tilde{y} 524, and \tilde{z} 526. In some embodiments, the second rigid body can correspond to the origin of the view frustum, the origin of the viewport, and/or any suitable parameter relating to the camera perspective of the active user.

In some embodiments, normal vector N 530 can be determined such that normal vector N 530 is normal to both z 516 and \tilde{z} 526. In some embodiments, angle α 532 can be the angle between x 512 and N 530. In some embodiments, angle γ 534 can be the angle between \tilde{x} 512 and N 530. In some embodiments, angle β 536 can be the angle between z 526 and \tilde{x} 536. In some embodiments, angles (α, γ, β) can be determined using any suitable mathematical technique, such as geometry (e.g., law of cosines, etc.), matrix and/or vector algebra, and/or any other suitable mathematical model.

Note that, in illustration 500, the two rigid bodies 510 and 520 are shown with a common origin point for each respective coordinate system. The above-mentioned Euler angles can additionally be determined for two rigid bodies that are separated by first determining the distance vector between the two rigid bodies in a global coordinate system (e.g., common to both rigid bodies) and then translating one of the two rigid bodies along the distance vector until the origin (or desired portion of each rigid body to be treated as the origin of the coordinate system) of each rigid body overlap in a global coordinate system. Such an example is shown in illustration 550 of FIG. 5B.

Turning to FIG. 5B, an example illustration 550 demonstrating rotation angles between an advertising object and a third-person camera viewport is shown in accordance with some embodiments of the disclosed subject matter. As shown, illustration 550 includes advertising object 110 with advertising image 120 and camera 130, as discussed above in FIG. 1. Additionally, illustration 550 includes ellipse 510 super-imposed upon advertising object 110, and similarly ellipse 520 super-imposed upon camera 130. As noted above in discussion of FIG. 5A, each ellipse 510 and 520 has an internal coordinate system, and the origin 560 of ellipse 510 is placed in the center of advertising image 120. Similarly, the origin 570 of ellipse 520 is placed at the origin of camera 130. As discussed above, distance vector 580 can be determined using, in some embodiments, world coordinates for each of ellipse 510 and 520 before further determinations are made (such as Euler angles) for the relative alignment of the camera 130 and the advertising object 110 and/or advertising image 120.

Turning to FIG. 6, an example illustration 600 demonstrating a relative scale metric for a curved advertisement is shown in accordance with some embodiments of the disclosed subject matter. As shown, illustration 600 includes center point 610, ellipse 620 with points 621-625 and ellipse 630 with points 631-640. In some embodiments, the center point 610 can be positioned in the center of the advertising object 110, and/or in the center of the advertising image 120 on advertising object 110.

In some embodiments, ellipses 620 and 630 can be calculated using any suitable mechanism. In some embodiments, ellipses 620 and 630 can be calculated using a width and a height of advertising image 120 as a scaling parameter, and center point 610 as the center of both ellipses 620 and 630. In some embodiments, any suitable quantity of ellipses can be calculated in addition to ellipses 620 and 630 shown in FIG. 6.

In some embodiments, points 621-625 and 631-640 can be determined by any suitable mechanism. In some embodiments, a set of coordinates using any suitable reference coordinate system (e.g., global world coordinates, object coordinates, camera coordinates) can be calculated for each of the points 621-625 and 631-640. In some embodiments, points 621-625 and 631-640 can be randomly distributed around the calculated ellipses 620 and 603 (respectively). In some embodiments, any suitable quantity of additional points can be calculated in addition to points 621-625 and 631-640 shown in FIG. 6.

In some embodiments, points 621-625 and 631-640 can be used to determine a relative scale of advertising image 120 in a viewport. For example, using a coordinate system 650, because advertising object 110 is a curved surface and advertising image 120 is wrapped around the curved surface, the points 631, 635, 636, and 640 (which are further away from the camera and/or user avatar along the curvature of advertising object 110) can have a different z-coordinate value than the points 621, 623, 624, 625, 637, and 639 (which are closer to the camera and/or user avatar along the curvature of advertising object 110). Additionally, in some embodiments, points 622, 632, 633, 634, and 638 can be discarded from any calculations relating to the scale of advertising image 120, as these points are positioned outside of advertising image 120. In some embodiments, any suitable mechanism can be used to determine that points 622, 632, 633, 634, and 638 are outside of advertising image 120. For example, in some embodiments, ray casting onto each of the points 621-625 and 631-640 can also allow for a determination of which rays pass through the advertising image 120 and also collide with one of the points 621-625 and 631-640. In some embodiments, coordinates of points 621, 623, 624, 625, 631, 635, 636, 637, 639, and 640 can be used to calculate a relative scale of advertising image 110 based on the distance of the camera to point 610.

Turning to FIG. 7, an example illustration of ray casting from a camera viewpoint to an advertising object in accordance with some embodiments of the disclosed subject matter is shown. As shown, illustration 700 in FIG. 7 includes the exemplary virtual environment scene as described above in FIG. 1. In addition, illustration 700 includes an occluding object 710 and ray casting 720.

Occluding object 710 can be any suitable object in the virtual environment having any suitable size, shape, dimensions, texture(s), transparency, and/or any other suitable object property. In some embodiments, occluding object 710 can be positioned between camera 130 and advertising object 110 such that a portion of advertising image 120 on advertising object 110 is obscured by occluding object 720, and that portion of the advertising image 120 is prevented from appearing on a viewport used by the active user. In particular, for the given position of camera 130 as shown in FIG. 7, any suitable quantity of rays used in ray casting 720 that start at the position of the camera 130 and which are aimed towards advertising object 110 and/or advertising image 120 can encounter occluding object 720.

In some embodiments, rays 721-724 can encounter and/or record a collision and/or primary collision with advertising object 130 and/or advertising image 140. Continuing this example, in particular, rays 725-727 can encounter and/or record a collision and/or primary collision with occluding object 710. Note that, in some embodiments, ray casting 720 can be configured to have an individual ray terminate upon a first collision. Alternatively, in some embodiments, ray casting 720 can be configured to have an individual ray continue upon the original path of the ray and pass through an object after a first collision and can record a second and/or any suitable number of additional collisions while traversing the original ray path set by ray casting 720.

In some embodiments, any suitable data can be recorded by ray casting 720. For example, in some embodiments, ray casting 720 can use any suitable quantity of rays that originate at any suitable positions (such as the origin of the viewport, the origin of the viewpoint, etc.). In some embodiments, ray casting 720 can cast a uniform distribution of rays throughout the view frustum. In some embodiments, ray casting 720 can cast a uniform distribution of rays that are restricted to any suitable angles within the view frustum. In some embodiments, ray casting 720 can use any suitable mathematical function to distribute rays, for example, using a more dense distribution of rays towards the center of advertising object 110.

In some embodiments, ray casting 720 can record any suitable number of collisions along a particular ray path. For example, in some embodiments, ray 721 can encounter advertising object 110 and ray casting 720 can record the distance and/or angles traveled by ray 721, the coordinates of the collision, any suitable information regarding the object contained at the collision such as a pixel (and/or voxel) color value, a texture applied to a region including the collision point, etc.

In some embodiments, data obtained by ray casting 720 can be used as a metric to quantify an amount of advertising image 120 that appears within a viewport associated with camera 130 and/or ray casting 720. For example, when camera 130 is at the location shown in FIG. 7A, the occluding object can cause any suitable amount of the advertising image to be obscured. In some embodiments, any suitable mechanism such as process 300 can determine a first quantity of primary collisions that occurred within the advertising object and/or advertising image. In some embodiments, any suitable mechanism such as process 300 can determine a second quantity of primary collisions that occurred with any object other than the advertising object. In some embodiments, any suitable combination of the first quantity of primary collisions, second quantity of primary collisions, distribution of rays across the view frustum, and/or total quantity of rays used in ray casting 720 can be used to determine a viewability metric using ray casting 720. For example, in some embodiments, a ratio of the rays which arrived at the advertising object (e.g., rays 721-724) to the total quantity of rays used in ray casting 720 can give a percentage of the amount of the advertising image viewable. In another example, in some embodiments, when a non-uniform distribution of rays is used, the distribution function can be incorporated to weight the ray collisions received from the more densely populated regions of rays within ray casting 720. In another example, in some embodiments, the second quantity of primary collisions, e.g., that encountered something other than the advertising object first, can be used to quantify the amount of the advertising image viewable.

In some embodiments, any additional analysis can be performed using the data acquired from ray casting 720.

Turning to FIG. 8, an example 800 of hardware for determining curved advertisement viewability in virtual environments in accordance with some implementations is shown. As illustrated, hardware 800 can include a server 802, a communication network 804, and/or one or more user devices 806, such as user devices 808 and 810.

Server 802 can be any suitable server(s) for storing information, data, programs, media content, and/or any other suitable content. In some implementations, server 802 can perform any suitable function(s).

Communication network 804 can be any suitable combination of one or more wired and/or wireless networks in some implementations. For example, communication network can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 806 can be connected by one or more communications links (e.g., communications links 812) to communication network 804 that can be linked via one or more communications links (e.g., communications links 814) to server 802. The communications links can be any communications links suitable for communicating data among user devices 806 and server 802 such as network links, dial-up links, wireless links, hard-wired links, any other suitable communications links, or any suitable combination of such links.

User devices 806 can include any one or more user devices suitable for use with block diagram 100, process 200, and/or process 300. In some implementations, user device 806 can include any suitable type of user device, such as speakers (with or without voice assistants), mobile phones, tablet computers, wearable computers, headsets, laptop computers, desktop computers, smart televisions, media players, game consoles, vehicle information and/or entertainment systems, and/or any other suitable type of user device.

For example, user devices 806 can include any one or more user devices suitable for requesting video content, rendering the requested video content as immersive video content (e.g., as virtual reality content, as three-dimensional content, as 360-degree video content, as 180-degree video content, and/or in any other suitable manner) and/or for performing any other suitable functions. For example, in some embodiments, user devices 806 can include a mobile device, such as a mobile phone, a tablet computer, a wearable computer, a laptop computer, a virtual reality headset, a vehicle (e.g., a car, a boat, an airplane, or any other suitable vehicle) information or entertainment system, and/or any other suitable mobile device and/or any suitable non-mobile device (e.g., a desktop computer, a game console, and/or any other suitable non-mobile device). As another example, in some embodiments, user devices 806 can include a media playback device, such as a television, a projector device, a game console, desktop computer, and/or any other suitable non-mobile device.

In a more particular example where user device 806 is a head mounted display device that is worn by the user, user device 806 can include a head mounted display device that is connected to a portable handheld electronic device. The portable handheld electronic device can be, for example, a controller, a smartphone, a joystick, or another portable handheld electronic device that can be paired with, and communicate with, the head mounted display device for interaction in the immersive environment generated by the head mounted display device and displayed to the user, for example, on a display of the head mounted display device.

It should be noted that the portable handheld electronic device can be operably coupled with, or paired with the head mounted display device via, for example, a wired connection, or a wireless connection such as, for example, a WiFi or Bluetooth connection. This pairing, or operable coupling, of the portable handheld electronic device and the head mounted display device can provide for communication between the portable handheld electronic device and the head mounted display device and the exchange of data between the portable handheld electronic device and the head mounted display device. This can allow, for example, the portable handheld electronic device to function as a controller in communication with the head mounted display device for interacting in the immersive virtual environment generated by the head mounted display device. For example, a manipulation of the portable handheld electronic device, and/or an input received on a touch surface of the portable handheld electronic device, and/or a movement of the portable handheld electronic device, can be translated into a corresponding selection, or movement, or other type of interaction, in the virtual environment generated and displayed by the head mounted display device.

It should also be noted that, in some embodiments, the portable handheld electronic device can include a housing in which internal components of the device are received. A user interface can be provided on the housing, accessible to the user. The user interface can include, for example, a touch sensitive surface configured to receive user touch inputs, touch and drag inputs, and the like. The user interface can also include user manipulation devices, such as, for example, actuation triggers, buttons, knobs, toggle switches, joysticks and the like.

The head mounted display device can include a sensing system including various sensors and a control system including a processor and various control system devices to facilitate operation of the head mounted display device. For example, in some embodiments, the sensing system can include an inertial measurement unit including various different types of sensors, such as, for example, an accelerometer, a gyroscope, a magnetometer, and other such sensors. A position and orientation of the head mounted display device can be detected and tracked based on data provided by the sensors included in the inertial measurement unit. The detected position and orientation of the head mounted display device can allow the system to, in turn, detect and track the user's head gaze direction, and head gaze movement, and other information related to the position and orientation of the head mounted display device.

In some implementations, the head mounted display device can include a gaze tracking device including, for example, one or more sensors to detect and track eye gaze direction and movement. Images captured by the sensor(s) can be processed to detect and track direction and movement of the user's eye gaze. The detected and tracked eye gaze can be processed as a user input to be translated into a corresponding interaction in the immersive virtual experience. A camera can capture still and/or moving images that can be used to help track a physical position of the user and/or other external devices in communication with/operably coupled with the head mounted display device. The captured images can also be displayed to the user on the display in a pass through mode.

Although server 802 is illustrated as one device, the functions performed by server 802 can be performed using any suitable number of devices in some implementations. For example, in some implementations, multiple devices can be used to implement the functions performed by server 802.

Although two user devices 808 and 810 are shown in FIG. 8 to avoid overcomplicating the figure, any suitable number of user devices, (including only one user device) and/or any suitable types of user devices, can be used in some implementations.

Server 802 and user devices 806 can be implemented using any suitable hardware in some implementations. For example, in some implementations, devices 802 and 806 can be implemented using any suitable general-purpose computer or special-purpose computer and can include any suitable hardware. For example, as illustrated in example hardware 900 of FIG. 9, such hardware can include hardware processor 902, memory and/or storage 904, an input device controller 906, an input device 908, display/audio drivers 910, display and audio output circuitry 912, communication interface(s) 904, an antenna 916, and a bus 918.

Hardware processor 902 can include any suitable hardware processor, such as a microprocessor, a micro-controller, digital signal processor(s), dedicated logic, and/or any other suitable circuitry for controlling the functioning of a general-purpose computer or a special-purpose computer in some implementations. In some implementations, hardware processor 902 can be controlled by a computer program stored in memory and/or storage 904. For example, in some implementations, the computer program can cause hardware processor 902 to perform functions described herein.

Memory and/or storage 904 can be any suitable memory and/or storage for storing programs, data, documents, and/or any other suitable information in some implementations. For example, memory and/or storage 904 can include random access memory, read-only memory, flash memory, hard disk storage, optical media, and/or any other suitable memory.

Input device controller 906 can be any suitable circuitry for controlling and receiving input from one or more input devices 908 in some implementations. For example, input device controller 906 can be circuitry for receiving input from a virtual reality headset, a touchscreen, from a keyboard, from a mouse, from one or more buttons, from a voice recognition circuit, from one or more microphones, from a camera, from an optical sensor, from an accelerometer, from a temperature sensor, from a near field sensor, and/or any other type of input device.

Display/audio drivers 910 can be any suitable circuitry for controlling and driving output to one or more display/audio output devices 912 in some implementations. For example, display/audio drivers 910 can be circuitry for driving a display in a virtual reality headset, a heads-up display, a touchscreen, a flat-panel display, a cathode ray tube display, a projector, a speaker or speakers, and/or any other suitable display and/or presentation devices.

Communication interface(s) 914 can be any suitable circuitry for interfacing with one or more communication networks, such as network 804 as shown in FIG. 8. For example, interface(s) 914 can include network interface card circuitry, wireless communication circuitry, and/or any other suitable type of communication network circuitry.

Antenna 916 can be any suitable one or more antennas for wirelessly communicating with a communication network (e.g., communication network 804) in some implementations. In some implementations, antenna 916 can be omitted.

Bus 918 can be any suitable mechanism for communicating between two or more components 902, 904, 906, 910, and 914 in some implementations.

Any other suitable components can be included in hardware 900 in accordance with some implementations.

In some implementations, any suitable computer readable media can be used for storing instructions for performing the functions and/or processes described herein. For example, in some implementations, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that at least some of the above-described blocks of processes 200 and 300 can be executed or performed in any order or sequence not limited to the order and sequence shown in and described in connection with FIGS. 2 and 3. Also, some of the above blocks of processes 200 and 300 can be executed or performed substantially simultaneously where appropriate or in parallel to reduce latency and processing times. Additionally or alternatively, some of the above described blocks of processes 200 and 300 can be omitted.

Accordingly, methods, systems, and media for determining curved advertisement viewability in virtual environments are provided.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for determining advertisement viewability in a virtual environment, the method comprising:
receiving, using a hardware processor, a content identifier for an advertising object in a virtual environment, wherein the advertising object contains an advertising image;
identifying, using the hardware processor, a viewport and a view frustum for a user in the virtual environment;
determining, using the hardware processor, a set of viewability metrics comprising (i) a location of a center of the advertising object relative to a boundary of the view frustum, wherein the location is within the boundary of the view frustum; (ii) a relative alignment between the advertising image and the viewport, wherein the relative alignment comprises an angle between a normal of the advertising object in a region where the advertising image is located and a direction vector between the origin of the viewport and a center of the advertising object; (iii) a relative scale of the advertising object, wherein the relative scale comprises a relative distance combined with a field of view of the view frustum, wherein the relative distance comprises a distance between the origin of the viewport and the center of the advertising object; and (iv) an amount of the advertising image that is visible to the user, comprising: producing a plurality of rays that originate at a center of the viewport and are oriented towards the advertising object, determining a quantity of rays from the plurality of rays that intersect at least one point on the advertising image; and determining a combination of the quantity of rays that intersect at least one point on the advertising image and a total quantity of rays in the plurality of rays; and
in response to determining the set of viewability metrics, associating, using the hardware processor, the target advertisement with a viewability rating.

2. The method of claim 1, wherein the relative alignment further comprises a relative rotation between the viewport and the center of the advertising object.

3. The method of claim 1, wherein the boundary of the view frustum is a plurality of planes.

4. The method of claim 1, wherein the viewability rating is determined based on a combination of the set of viewability metrics.

5. The method of claim 4, wherein the combination further comprises weighting each metric in the set of viewability metrics with a non-zero weight.

6. The method of claim 1, wherein at least a portion of the advertising object contains a curved surface.

7. A system for determining advertisement viewability in a virtual environment, the system comprising:
a hardware processor that is configured to:
receive a content identifier for an advertising object in a virtual environment, wherein the advertising object contains an advertising image;
identify a viewport and a view frustum for a user in the virtual environment;
determine a set of viewability metrics comprising (i) a location of a center of the advertising object relative to a boundary of the view frustum, wherein the location is within the boundary of the view frustum; (ii) a relative alignment between the advertising image and the viewport, wherein the relative alignment comprises an angle between a normal of the advertising object in a region where the advertising image is located and a direction vector between the origin of the viewport and a center of the advertising object; (iii) a relative scale of the advertising object, wherein the relative scale comprises a relative distance combined with a field of view of the view frustum, wherein the relative distance comprises a distance between the origin of the viewport and the center of the advertising object; and (iv) an amount of the advertising image that is visible to the user, comprising: producing a plurality of rays that originate at a center of the viewport and are oriented towards the advertising object, determining a quantity of rays from the plurality of rays that intersect at least one point on the advertising image; and determining a combination of the quantity of rays that intersect at least one point on the advertising image and a total quantity of rays in the plurality of rays; and
in response to determining the set of viewability metrics, associate the target advertisement with a viewability rating.

8. The method of claim 7, wherein the relative alignment further comprises a relative rotation between the viewport and the center of the advertising object.

9. The method of claim 7, wherein the boundary of the view frustum is a plurality of planes.

10. The method of claim 7, wherein the viewability rating is determined based on a combination of the set of viewability metrics.

11. The method of claim 10, wherein the combination further comprises weighting each metric in the set of viewability metrics with a non-zero weight.

12. The method of claim 7, wherein at least a portion of the advertising object contains a curved surface.

13. A non-transitory computer-readable medium containing computer executable instructions that, when executed by a processor, cause the processor to perform a method for determining advertisement viewability in a virtual environment, the method comprising:
receiving a content identifier for an advertising object in a virtual environment, wherein the advertising object contains an advertising image;
identifying a viewport and a view frustum for a user in the virtual environment;
determining a set of viewability metrics comprising (i) a location of a center of the advertising object relative to a boundary of the view frustum, wherein the location is within the boundary of the view frustum; (ii) a relative alignment between the advertising image and the viewport, wherein the relative alignment comprises an angle between a normal of the advertising object in a region where the advertising image is located and a direction vector between the origin of the viewport and a center of the advertising object; (iii) a relative scale of the advertising object, wherein the relative scale comprises a relative distance combined with a field of view of the view frustum, wherein the relative distance comprises a distance between the origin of the viewport and the center of the advertising object; and (iv) an amount of the advertising image that is visible to the user, comprising: producing a plurality of rays that originate at a center of the viewport and are oriented towards the advertising object, determining a quantity of rays from the plurality of rays that intersect at least one point on the advertising image; and determining a combination of the quantity of rays that intersect at least one point on the advertising image and a total quantity of rays in the plurality of rays; and
in response to determining the set of viewability metrics, associating the target advertisement with a viewability rating.

14. The non-transitory computer-readable medium of claim 13, wherein the relative alignment further comprises a relative rotation between the viewport and the center of the advertising object.

15. The non-transitory computer-readable medium of claim 13, wherein the boundary of the view frustum is a plurality of planes.

16. The non-transitory computer-readable medium of claim 13, wherein the viewability rating is determined based on a combination of the set of viewability metrics.

17. The non-transitory computer-readable medium of claim 16, wherein the combination further comprises weighting each metric in the set of viewability metrics with a non-zero weight.

18. The non-transitory computer-readable medium of claim 13, wherein at least a portion of the advertising object contains a curved surface.
